(19) United States
(12) Patent Application Publication
(10) Pub. No.: US 2005/0261928 A1
(43) Pub. Date: Nov. 24, 2005

(54) System and method for managing content displayed on a distributed network of signs

(76) Inventor: Christos Skeadas, Villanova, PA (US)

Correspondence Address: PILLSBURY WINTHROP SHAW PITTMAN, LLP, P.O. BOX 10500, MCLEAN, VA, 22102, US

(21) Appl. No.: 11/007,439

(22) Filed: Dec. 8, 2004

Related U.S. Application Data
(60) Provisional application No. 60/528,119, filed on Dec. 8, 2003.

(51) Int. Cl. G06F 17/60

(52) U.S. Cl. 705/1; 705/26

(57) ABSTRACT

A system and method for managing content displayed on a distributed network of signs in enterprise and non-enterprise embodiments is disclosed. In an enterprise embodiment, a hierarchy is developed to manage sign data across multiple levels. In a retail embodiment, the levels may include chains, geographic regions, and/or stores. On-site processors are used to distribute and store information pertaining to a particular location. In a non-enterprise embodiment, signs at a single location are centrally managed. Information is stored in a central database and is sent to individual signs continuously, intermittently or as requested. A web management interface (“WMI”) is used to manage the information pertaining to each sign, including content to display, the timing for displaying the content and the applicable fields. An error checking scheme is implemented to verify that sign content is appropriately displayed.

### CROSS-REFERENCE TO RELATED APPLICATIONS

The present application claims priority to U.S. Provisional Application No. 60/528,119, filed on Dec. 8, 2003 and entitled System and Method for Managing Content Displayed on a Distributed Network of Signs, which disclosure is incorporated herein by reference in its entirety.

### BACKGROUND

Disclosed is a system and method in which the content displayed on a network of signs can be created, modified and displayed on one or more of the signs in remote locations. The content to be displayed and the schedule on which each sign's content is updated and/or displayed may be predetermined and/or obtained from an external system such as the network of a customer utilizing the sign network, or remotely managed by an external user interface, which may include a web-based interface.

Signs are often displayed in such places as retail stores, conference rooms or airport terminals to provide information to people. A retail store may use a sign to denote a type of good for sale and the price of the good. A conference room may have a sign associated with it that informs people as to the group that is meeting in the conference room. Airport terminals have signs describing flight information at each gate. Additional information may be described as well in each of these or other venues.

Conventional signs are typically paper-based and static. Accordingly, in order to reflect updated information, the existing sign displaying the old information must be replaced with a new sign that contains the updated information. Replacing such signs throughout, for example, a store, conference center or airport terminal can require a significant number of man-hours depending upon the size of the facility and the frequency with which information is updated. This may require numerous individuals dedicated to the task of replacing signs throughout even a single facility. This is, of course, magnified when a single enterprise has multiple facilities, as not only are more signs needed to be replaced, but there are significant logistical issues with delivering new signs to multiple locations.

Additionally, a consumer in a retail store may require additional information regarding a product in order to make an informed purchasing decision. Currently, the consumer may have to leave the location where the product is located to find a salesperson or customer service representative to obtain additional information. The time spent searching for and obtaining information from a customer representative may lead to diminished satisfaction on the part of the consumer. Moreover, the customer representative may be unable to perform other tasks while assisting the consumer, leading to a potential decrease in productivity.

An existing method of updating retail signs is described in U.S. Pat. No. 5,473,146, to Goodwin. However, this and other prior art methods require separate computer or systems to be located at the point of sale, and they do not provide an adequate ability to display several types of information on a single sign.

What is needed is a more efficient method and system for updating, modifying, or creating information for signs.

A further need exists for a method and system of remotely updating sign information on an electronic sign.

A further need exists for a method and system of controlling sign information throughout one or more related facilities from a remote location.

A still further need exists for a method and system for automatically providing information in response to a consumer request where the information is updated remotely.

The present methods and systems are directed towards solving one or more of these problems.

### SUMMARY

Aspects disclosed herein include
a computer-readable medium comprising program instructions thereon that instruct a computer to
receive data corresponding to a campaign;
retrieve, from a content database, sign data corresponding to the campaign;
select one or more signs within a sign network to which the sign data applies; and
selectively transmit, via a communications network, at least a portion of the sign data to the selected one or more signs;
a system for managing content displayed on a distributed network of signs, comprising
a central processor;
a computer-readable storage medium operably connected to the central processor;
a communications network operably connected to the central processor;
one or more on-site processors operably connected to the communications network; and
one or more first signs, wherein each first sign is operably connected to at least one on-site processor;
wherein the computer-readable storage medium comprises program instructions for performing a method of managing content displayed on a distributed network of signs, the method comprising
   creating sign data pertaining to a campaign and at least one first sign within the network of signs;
   storing the sign data in the computer-readable storage medium,
   transmitting at least a portion of the sign data to an on-site processor operably connected to a first sign to which the portion of the sign data pertains;
   transmitting the portion of the sign data to the first sign to which the portion of the sign data pertains; and
   updating the first sign based on the transmitted portion of the sign data; and
a method for managing content displayed on a distributed network of signs, the method comprising
creating sign data pertaining to a campaign;
transmitting at least a portion of the sign data to an on-site processor operably connected to a gateway;
transmitting the portion of the sign data to the gateway;

transmitting the portion of the sign data to a sign to which the portion of the sign data pertains; and
updating the sign based on the transmitted portion of the sign data.

### BRIEF DESCRIPTION OF THE DRAWINGS

FIG. 1 shows a block diagram of an exemplary embodiment in which the various components among the corporate headquarters, individual retail store locations and display locations on the store floor.

FIG. 2 depicts an exemplary enterprise embodiment in which data is stored at a central data storage device.

FIG. 3 is a screen shot of an exemplary campaign selection screen according to an embodiment.

FIG. 4 is a screen shot of an exemplary item selection screen according to an embodiment.

FIG. 5 is a screen shot of an exemplary target device selection screen according to an embodiment.

FIG. 6 is a screen shot of an exemplary content creation screen according to an embodiment.

FIG. 7 is a screen shot of an exemplary store management screen according to an embodiment.

FIG. 8 is a screen shot of an exemplary attribute modification screen according to an embodiment.

FIG. 9 is a screen shot of an exemplary campaign management, creation and modification screen according to an embodiment.

FIG. 10 is a screen shot of an exemplary campaign item designation screens according to an embodiment.

FIG. 11 is a screen shot of an exemplary content management screen according to an embodiment.

FIG. 12 depicts an exemplary enterprise system architecture according to an embodiment.

FIG. 13 depicts an exemplary non-enterprise system architecture according to an embodiment.

FIG. 14 depicts exemplary search functionality available through a user interface.

FIG. 15 is a screen shot of an exemplary campaign creation and management screen according to an embodiment.

### DETAILED DESCRIPTION

For purposes of this application, the term “sign” or “device” shall mean any display device which may be capable of dynamically changing context being displayed. In this regard, “sign” or “device” shall be deemed to include segmented displays, all points addressable displays, bi-stable displays, active matrix based displays, passive matrix based displays, LCD displays, plasma displays, LEDs, CRTs, SmartPaper™ based displays, non-SmartPaper™ based displays, other known display media and all equivalents thereof. In addition, the system may be utilized with the Shopper's Answering Machine and similar or equivalent devices which is described more fully below.

In embodiments there is illustrated:
a system for the administration and management of a distributed network of signs comprising a server computer to determine the content to be displayed on a sign or group of signs and to cause such content to be displayed based on predetermined schedules or upon demand by user intervention. The administration and management of the network of signs may be accomplished by a user interface, such as a graphical user interface, or pursuant to a set of instructions previously provided to the server computer. The sign is notified by the server computer to retrieve the new content to be displayed on the sign and to gather local information and return it to the server. The server may also construct new content and instruct the sign to retrieve and display new or different content, or a specific web page which may contain control information.

Alternatively, the administration and management of the network of signs may be accomplished by interfacing the network of signs with an external network such as an internal network of the user of the network of signs. The system and method described herein provide for the creation of a campaign that manages the content on subsets of the plurality of signs as required by their individual design specifications, the content of the individual signs, and the schedule of display of this content.

In addition, a non-intrusive customizable solution is disclosed which may operate effectively on any computer platform. Components communicate with each other using sockets and TCP/IP. Optionally, other protocols, including proprietary protocols may be utilized. By utilizing socket-based communication, the various components comprising the system may be located on different computers, which may themselves be physically located across a wide region. In addition, the modules can be easily replaced or upgraded and if a particular computer should fail, the component could be run on a different computer seamlessly.

Furthermore, direct access to customer databases in order to create and schedule updated messages is not required. An interface has been developed which functions to link the proprietary data in a customer's database with the signs located on a storeroom floor. The interface maps existing customer data into a format conducive for use in content to be displayed on a sign, while maintaining the integrity of the customer database.

In addition, the use of mobile handheld devices which allow sign content to be updated by employees of a store located on the store floor are disclosed. The handheld devices provide wireless access to the server computer located at the particular store (i.e. the in store processor or ISP) and can be used to associate a given sign with a new product or new location in the store.

The present method and system may be implemented in either an enterprise-wide environment or a non-enterprise-wide embodiment. In the enterprise environment, data defining the enterprise, the devices in the enterprise, and the campaigns to be run are stored on a central data storage device. This content and scheduling data may be created remotely via a web interface allowing the input and manipulation of the data using devices such as a personal computer, handheld scanners, the Shopper's Answer Machine™ (“SAM”) which is described more fully below, or similar devices. In addition, the content and scheduling data may also be obtained from an external computer system, which may be a customer computer system or the computer system for a particular location. The content is then distributed to a plurality of signs pursuant to the campaign schedule and in response to a request for information by the individual signs.

### Enterprise Embodiment

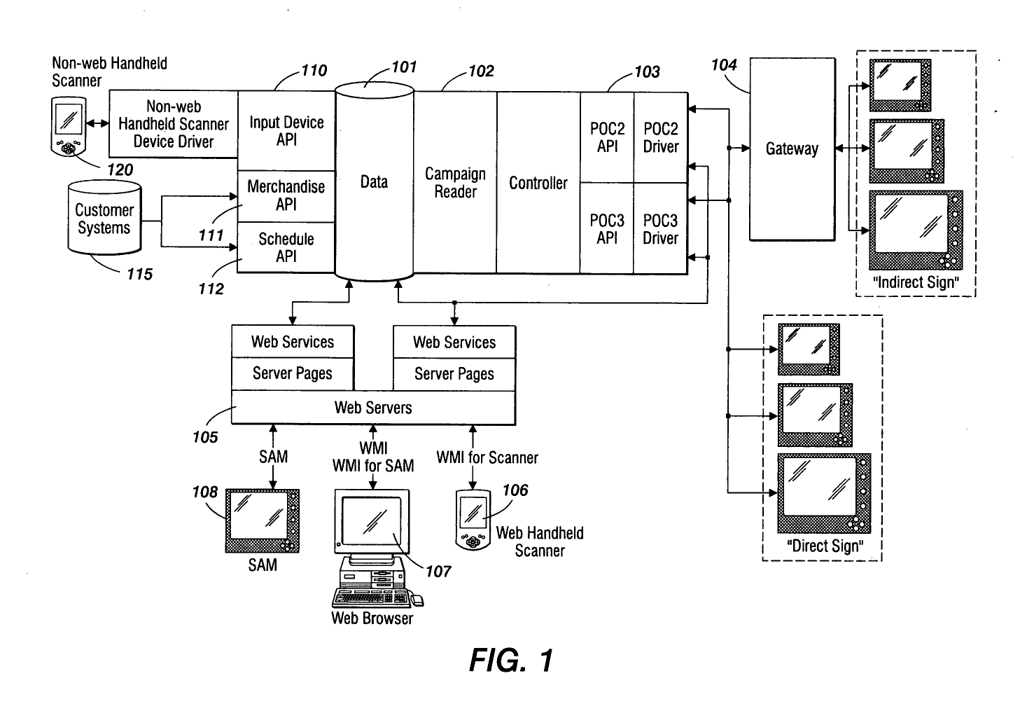

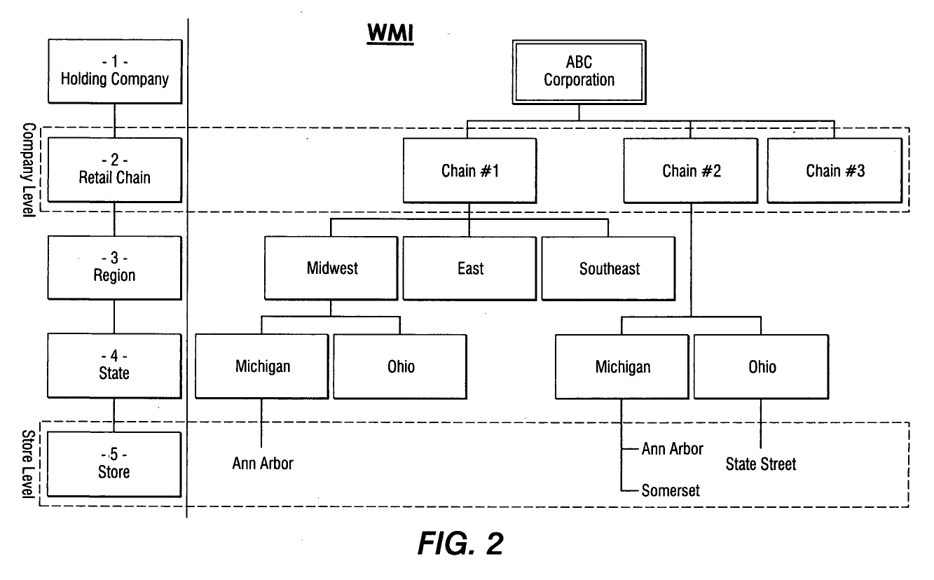

FIG. 1 depicts an exemplary enterprise embodiment in which data is stored at a central data storage device 101 wherein the data comprises a definition of the enterprise within which the signs will be installed, the schedule or campaign by which the signs will display content, an identification of the signs to be displayed, and the content to be displayed. In this context, the enterprise defines the various locations and hierarchy of relationships between various divisions, locations or entities. As illustrated in FIG. 2, the enterprise may be a holding company which includes one or more retail chains, in one or more regions, where the regions may include one or more states. At the lowest level of the enterprise, individual store locations may be within a particular state. Multiple retail chains may be held by a single holding company. Each of the retail chains may have multiple regions and locations in multiple states. Defining the enterprise in this manner allows for a flexible definition in which similar levels within the corporate structure may be omitted or explained in greater detail.

In the context of this disclosure, a campaign is defined as the content of an individual sign, the relationship of that content to an item or items in an external database and a schedule for displaying this content on the given sign. A campaign may be configured to meet the various needs of a given customer, location or item. By way of example, a default content display may be available to be displayed on the sign at all times throughout the campaign. However, at particular intervals, the content may be changed to reflect a sale, clearance, final markdown or other required content changes. Similarly, one or more events may be displayed at predefined intervals.

Returning to FIG. 1, in this embodiment the campaign reader 102 is responsible for determining the appropriate content for the appropriate sign and providing that information to the controller 103. The controller 103, in turn, is responsible for managing the delivery of content to the sign in accordance with the campaign schedules. A controller 103 is responsive to requests initiated by the individual signs, which may be in direct wireless communication with the controller 103 via established protocols, or in indirect wireless communication via a gateway 104. Signs in direct wireless communication with the controller 103 may be configured to include a radio transceiver for the receipt and transmission of data. Signs that are only indirectly in communication with the controller 103, that is, via the gateway 104, may not have a radio transceiver and thus may be constructed at a lesser expense. The present systems and methods are equally effective in controlling signs in either direct or indirect communication with the controller 103 and may be designed to control either or both as may be required by a particular enterprise. Typically, communication with the signs, either directly or with the sign gateway 104 in the indirect instance, will be via known wireless communication methods such as 802.11(b) or 802.11(a), or any other wireless data communication protocol. In an embodiment, communication may also be via wire-based communication.

Also illustrated in FIG. 2 is a web management interface to the central data storage device 101. The web management interface (“WMI”) permits the remote creation and modification of the campaign on the central data storage device 101, the definition of the signs which may be used in the system, the definition of the enterprise, the attributes which each sign may have and, the content to be displayed on each of the signs. The WMI may include one or more web servers 105 configured to communicate via the Internet with remotely located devices such as a web-enabled handheld scanner 106, a web browser 107 or a SAM 108. Appropriate interfaces and drivers are provided for each device communicating with the central data storage device 101 via the web server 105.

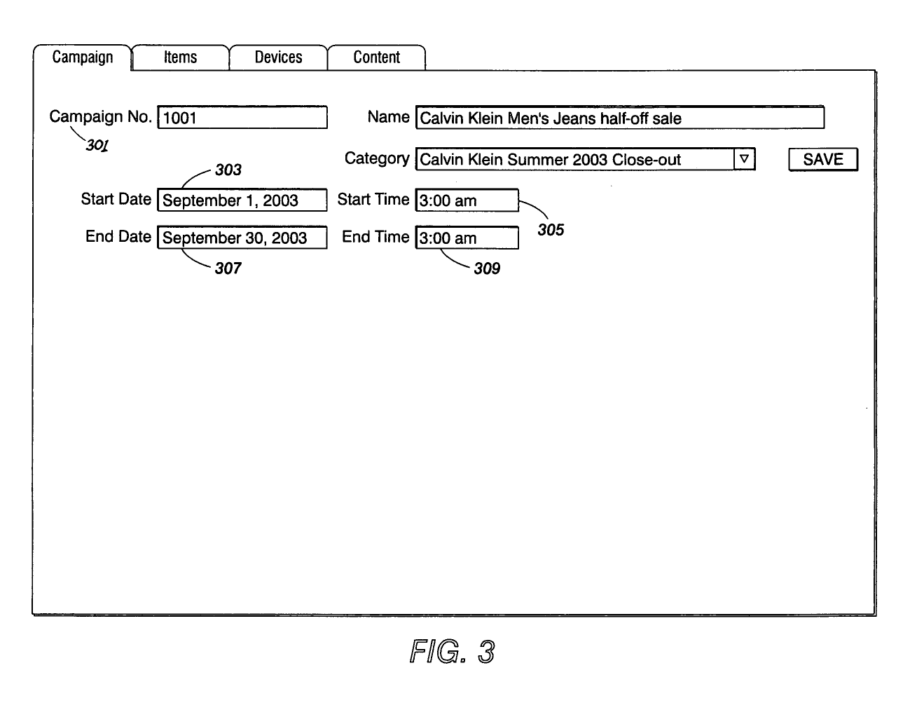

The WMI may allow a remotely located user to create and control the details of a merchandising campaign via a series of graphical interfaces. For example, FIG. 3 illustrates a screen shot of an exemplary campaign selection screen which may be accessed via the WMI. Via this campaign selection screen, a user can remotely select the campaign 301 to be run, its starting date 303 and time 305, and its ending date 307 and time 309.

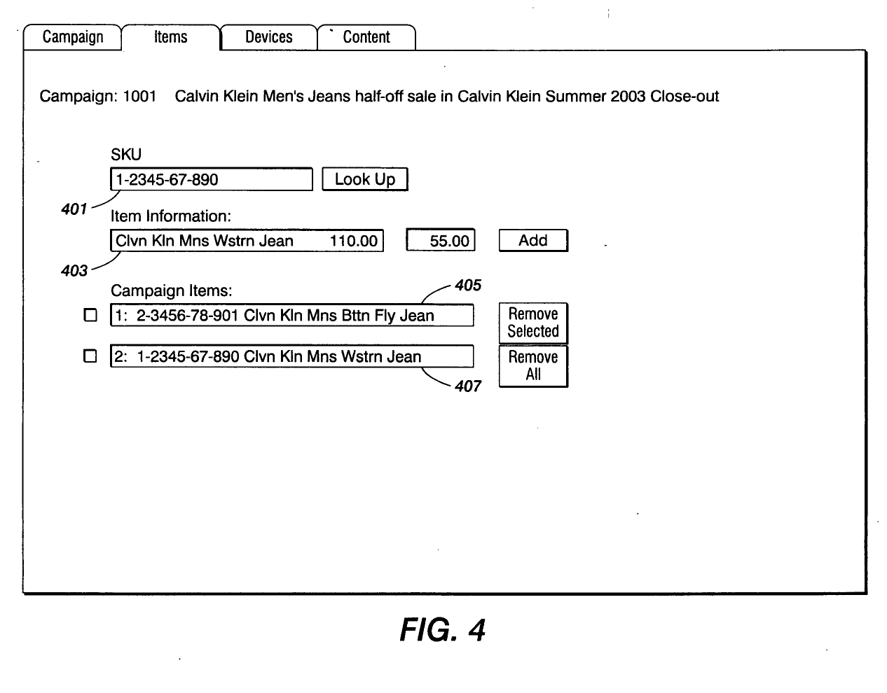

FIG. 4 illustrates a screen shot of an exemplary item selection screen which allows a user to lookup items using a stock keeping unit (“SKU”) number 401. The SKU may be entered either manually by a user or automatically by a handheld scanner or SAM 108. Utilizing this information, item identification 403 is available to the WMI in addition to the campaign items 405, 407.

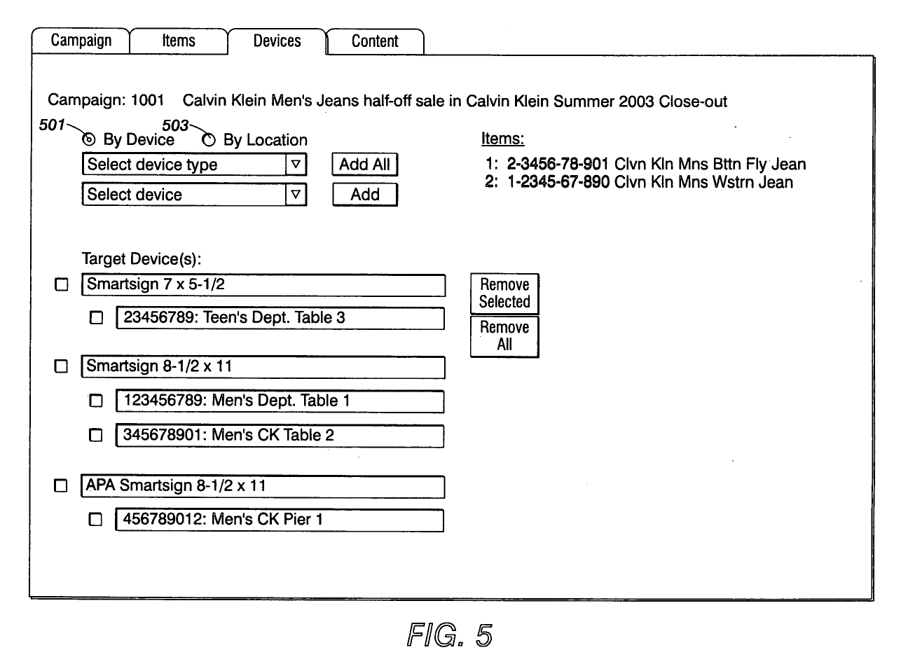

FIG. 5 illustrates a screen shot of an exemplary target device selection screens which a user may access via the WMI. This device selection screen allows a user to select and modify the selection of those signs on which the campaign for the given item will be performed. As demonstrated in FIG. 5, the selection may be made on a device-by-device basis 501 allowing a user to select the appropriate device on which the campaign should be run. Alternatively, device selection may be based on location 503, which allows a user to select a campaign to be run via the WMI on a location-by-location basis.

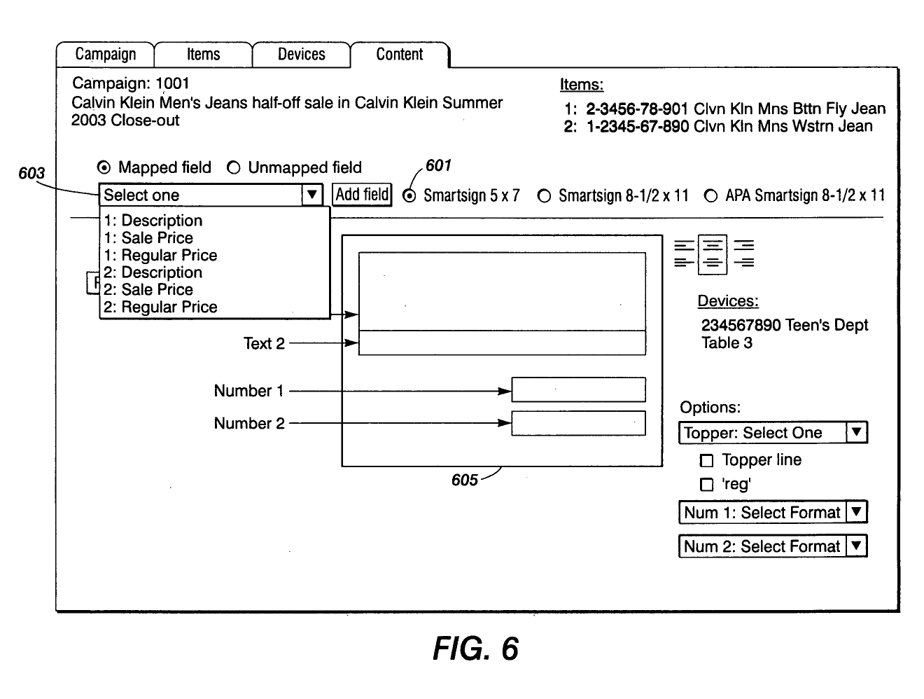

FIG. 6 illustrates a screen shot of an exemplary content creation screens that are accessible to the user via the WMI. The user may select which fields to display and the format of those fields. The user may further populate those fields with appropriate data via a content creation screen. For example, the user may select a sign size 601, a field 603 such as sale price, regular price or other item, a numeric and/or text description 605. The screen may allow a user to have data displayed in particular locations on one or more particular devices. In addition to use with a segmented sign, the content selection mechanism may be useful with respect to an all points addressable sign, which allows the user to dynamically configure the location of content to be displayed. The use of a content selection methodology via the WMI may be useful regardless of the type of device used to display the content as it may be configured for all types of content display devices.

The WMI may also provide administrative functionality which allows remote users to define and manage the enterprise. For example, the WMI may allow a remote user to access a screen for defining the organization and structure of the company, such as by defining the corporate in order to build the headquarters, divisions, geographic regions, stores, departments within stores, or other features. The screen may also allow the user to identify the various locations at which signs may be erected and made a part of the system.

The WMI may also include a department configuration screen by which administrative functionality is accessible. The functionality may allow a remote user to configure the departments available at a particular location. Using the functionality, the remote user will be able to identify the departments in each of the selected locations. The WMI may also include a category creation and modification screen, which may allow the user to aggregate information for campaigns. For example, the user may define a category as a “White Sale” or “President's Day Sale” and create information that is relevant to the campaign, such as start and end dates and times.

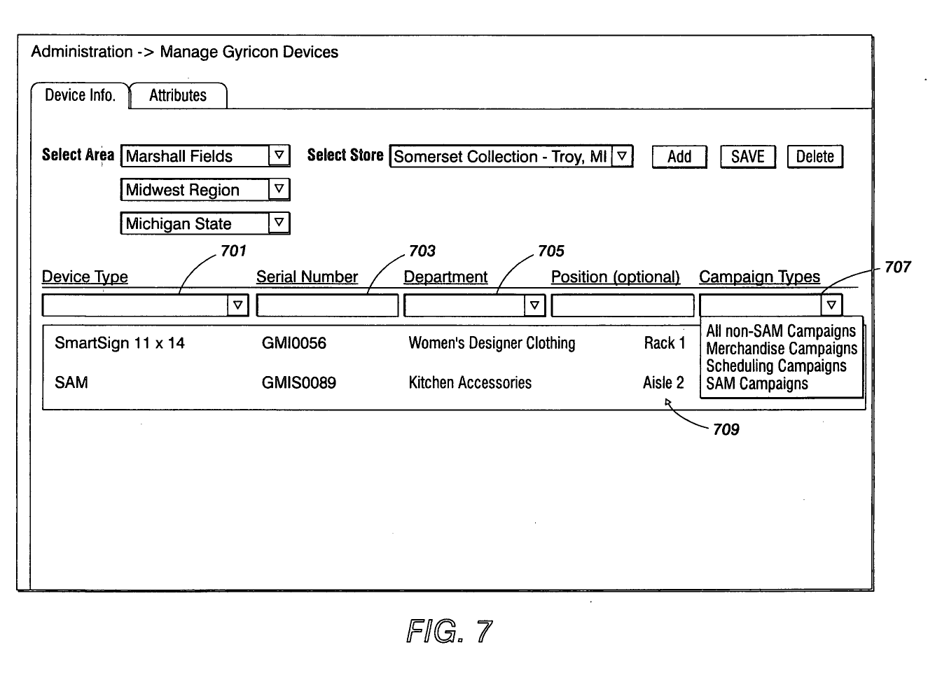

The WMI may also provide for remote accessibility for configuring information and attributes with respect to each sign used in the system. FIGS. 7 illustrates a screen shot of an exemplary store management screen accessible via the WMI that allows a remote user to review the devices available on a store-by-store basis. As demonstrated in FIG. 7, information may be provided, on a store-by-store basis, for signs 701, serial numbers 703, departments within which particular signs are located 705, and/or campaigns 707 associated with each sign. Optionally, the user may specify or identify the position of the signs in greater detail such as by rack number or aisle number 709.

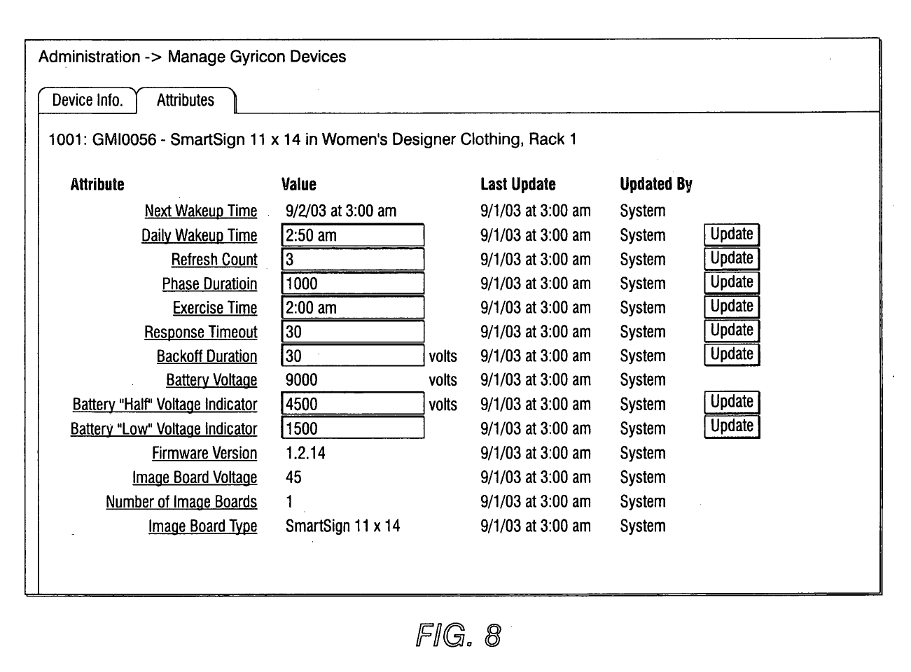

FIG. 8 illustrates screen shots of an exemplary attribute modification screen that may be available via the WMI. The exemplary attribute modification screen shown in FIG. 8 may allow a remote user to configure and/or obtain information regarding the physical characteristics of a sign within the network. For example, the attribute modification screen may allow a user to view and/or modify the wake up schedule for a sign, which dictates when the sign will power its communication devices and query the controller for updated content information, exercise time, and response timeout. Additional information may be displayed regarding the physical characteristics of the sign such as the power source, sign type, and firmware version number.

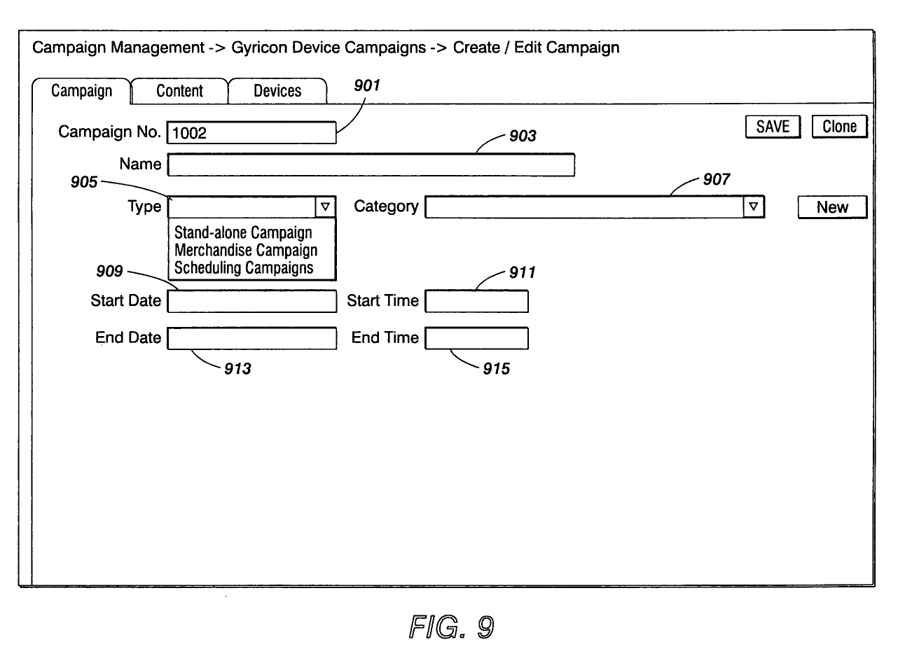

The WMI may provide additional functionality allowing for the creation and editing of a campaign by remote user. For example, as demonstrated in the exemplary campaign management screens of FIG. 9, the remote user may identify a campaign by a campaign number 901 and/or name 903, designate the type of campaign 905 and/or the category 907 within which it will fall, the pertinent starting date 909 and times 911, and ending date 913 and times 915 for a given campaign. Optionally, the campaign management screens may allow the remote user to designate multiple campaigns to run successively and/or concurrently.

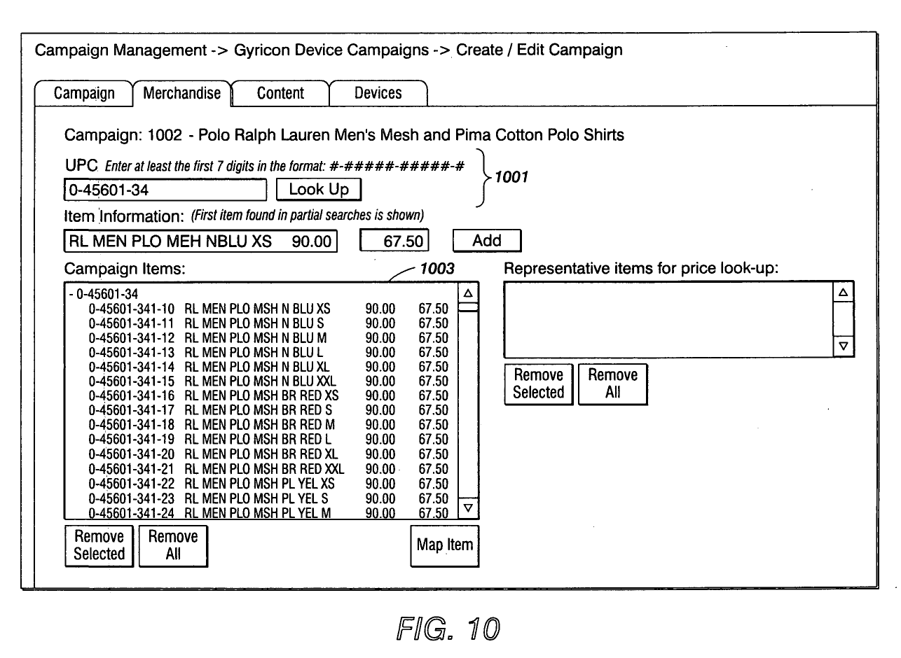

Optionally, a user may designate one or more items to be included in a campaign. For example, as shown in FIG. 10, items may be identified under an item selection screen by way of, for example, their UPCs 1001. Identified items may be displayed together in a campaign summary 1003 with pertinent pricing information. Items included in the campaign may be displayed to the user, who may remove or add additional items as needed.

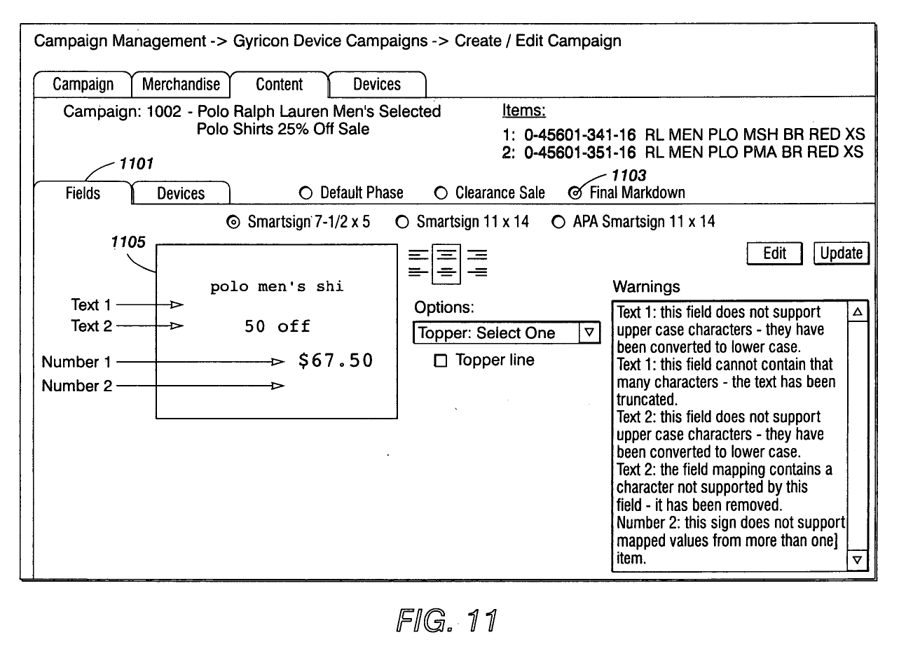

FIG. 11 is a screen shot of an exemplary content management screens for the campaign management functionality accessible by a remote user through the WMI. Each phase of the campaign may require a separate campaign or phase identifier, such as start, clearance and/or final markdown in order to ensure that the appropriate content is displayed to the consumer. Content may be managed based on the fields which are available or based on the devices which are used in the campaign. For example, as shown in FIG. 11, a campaign 1101 may include a phase selector 1103, after which the user may select content such as pricing and item information 1105 to be displayed on a sign on a device-by-device basis. In an embodiment, the content may be configured for each device and for each phase of the campaign. Optionally, the devices which are utilized during the campaign may first be defined or selected on a geographical basis, or by “scope,” where the departments within each state in the region may also be defined. This functionality may allow a remote user to add new devices and select devices to be used as part of the campaign for the given items. Optionally, when defining fields to be included in a sign, the WMI may provide warnings or alerts when errors or other specific events occur, such as too many characters or an invalid entry.

Heretofore, the WMI has been described in conjunction with a retail environment. However, one skilled in the art will appreciate that the WMI is configurable to any environment in which a distributed plurality of signs with changing and/or changeable content may be deployed. In particular, by way of example, the present system, including the WMI, may be useful in managing the use of conference rooms at hotels, convention centers, or the like. The functionality of the WMI need not change depending upon the deployment in differing environments. However, in an embodiment it is configurable to the display of content outside of the retail environment, such as in the conference room scheduling environment. In such an embodiment, only the subject of the content need change. For example, the sign may reference to “rooms” as opposed to “merchandise”. Accordingly, in such an embodiment the campaigns can be selected and run on a room-by-room basis to identify the activities occurring therein or any other information. This campaign type is therefore called a scheduling campaign.

Returning to FIG. 1, optional interfaces to the customer systems are shown. In particular, an input device API 110 may allow a customer to use a non web-enabled handheld scanner 120 to interface with the central data storage device 101. In addition, a merchandise API 111 and a schedule API 112 may be provided to interface with one or more customer systems 115, which may include an additional data storage devices and/or networks utilized by the customer to manage inventory, sales and/or other aspects of a particular business.

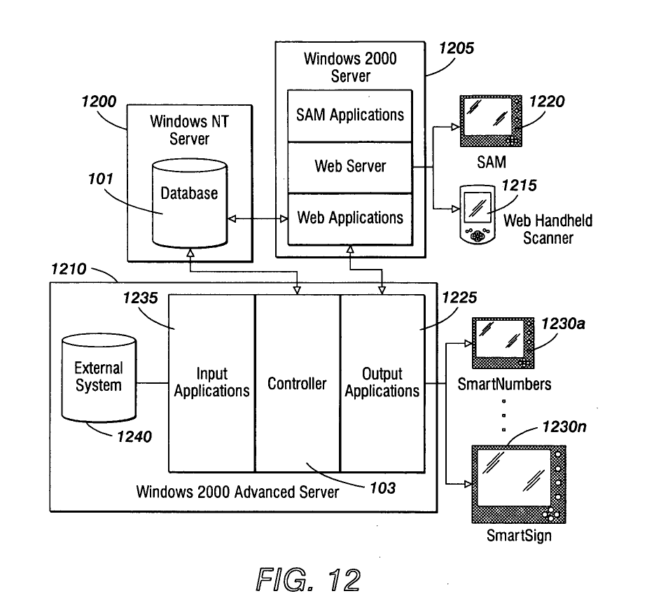

FIG. 12 illustrates an exemplary architecture on which the system may be deployed in an enterprise environment. As demonstrated in FIG. 12, a multi-tier architecture is utilized wherein a data storage server 1200 is in communication with a web server 1205 and a controller server 1210. The data server 1200 contains the central data storage device 101 discussed in conjunction with FIG. 2. The web server 1205 provides the platform for the interfaces for remote setup and configuration of campaigns and content creation and modification via external devices, such as a web-enabled handheld scanner 1215, a SAM 1220, or a web browser (not shown). The controller server 1210 may support the software controller 103 described in conjunction with FIG. 1. Also supported on the controller server 1210 may be an output applications interface 1225 for communicating with the deployed signs 1230a . . . n. In addition, the controller may use an input application 1235 to interface with one or more external systems 1240, which may include the customer's network and/or databases containing inventory and other information pertinent to the content being displayed on the signs.

### Non-Enterprise Embodiment

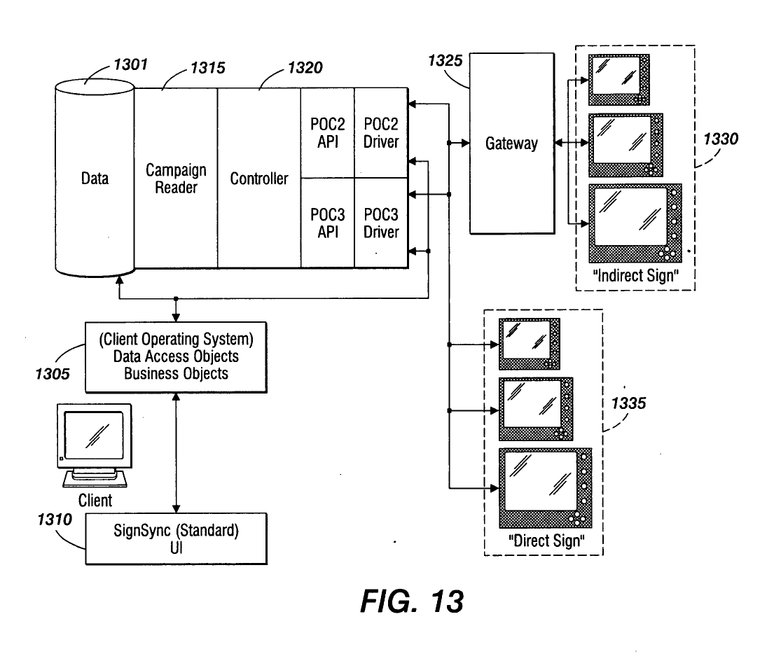

FIG. 13 depicts an exemplary non-enterprise system architecture for supporting a single or a small number of signs. The data storage device 1301 stores campaign and content data for use in managing a single or small number of signs. The data storage device 1301 may be populated with the necessary data by an interface to the client operating system 1305 which may provide a user interface 1310 for creating and modifying campaign and content data. The campaign reader 1315 determines the appropriate content for the appropriate sign and provides that information to the controller 1320. The controller 1320, in turn, is responsible for managing the delivery of content to a sign in accordance with the campaign schedules. The controller 1320 is responsive to requests initiated by the sign which may be in direct wireless communication with the controller 1320 via established protocols, or in indirect wireless communication via a gateway 1325. If the sign such as 1335 is in direct wireless communication with the controller 1320, it will be configured to include a radio transceiver for the receipt and transmission of data. Signs such as 1330 in indirect communication with the controller via the gateway 1325 are not configured to include a transceiver and thus may be constructed at lesser expense. The present systems and methods are equally effective in controlling signs in either direct or indirect communication with the controller and may be designed to control either or both as may be required by a particular enterprise. Typically, communication with the signs, either directly or with the sign gateway in the indirect instance, may be via known wireless communication methods such as 802.11(b) or 802.11(a), or any other wireless data communication protocol. In an embodiment, communication may also be via wire-based communication.

The user interface 1310 may permit a user on the client system to create and modify campaigns and content to be displayed on the sign. The user interface 1310 is discussed more fully above. Example features of the user interface are that it may show all of the campaigns scheduled on a given day for each sign, or it may show the daily schedule for individual signs. Furthermore, the campaigns may be managed on a weekly basis for either all of the signs or for individual signs. Optionally, campaigns may also be managed on a monthly basis for all signs or individual signs.

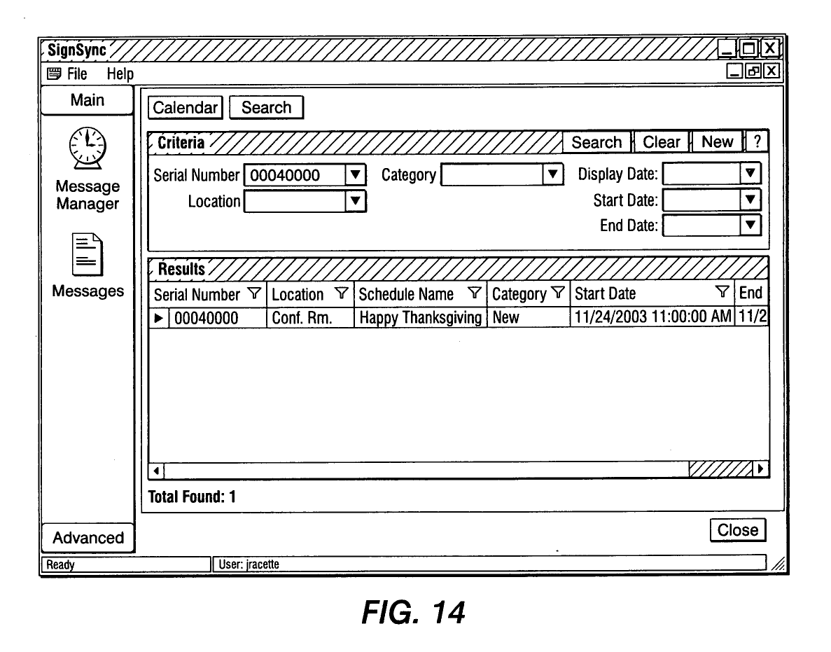

The user interface may also include search functionality. For example, in an embodiment users may search for existing campaigns which may have been scheduled in a variety of modes and utilizing a variety of search parameters. For example, a search for all campaigns scheduled for all signs may be used or the user may search for campaigns scheduled for individual signs. Search parameters may include, for example, display date, start date for the campaign, end date for the campaign, location of the signs involved in the campaign, and/or the category within which the campaign may be found. The data accessible through the search functionality may include the serial or other identifying number for the sign, the location of the sign, the campaign name (also referred to as the schedule name), the category of the campaign, the starting and ending times, and/or other relevant information which may be selected. An exemplary screen shot showing a user interface with search criteria and results is shown in FIG. 14.

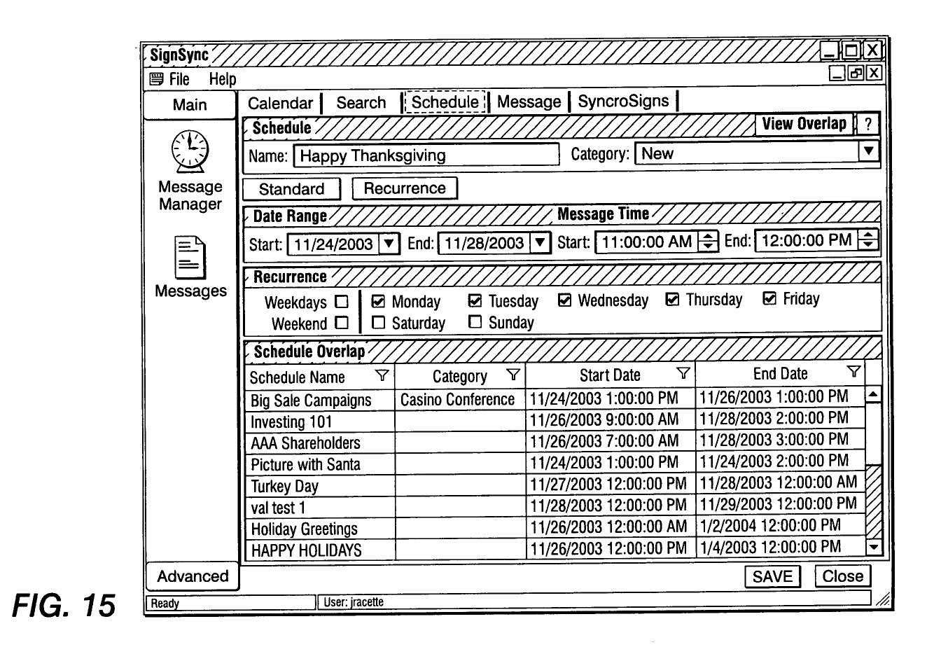

The user interface may allow the user to create new campaigns or schedules as needed. An exemplary campaign creation and management screen is illustrated in FIG. 15. As demonstrated in FIG. 15, the campaign creation and management screen may allow a user to create a new campaign, assign the campaign a unique name, assign the campaign to a category and configure the campaign to the specific needs of the client. For example, the campaign may be created as a standard (or non-recurring) campaign which runs only once per scheduled occurrence. Alternately, the campaign may be created as a recurring campaign, which may run repeatedly until manually terminated. The campaign creation and management screen allows a user to select the starting date and time, the ending date and time, and the days on which the campaign will be run. In addition, existing campaigns that overlap with the created campaign may be displayed for the user. Optionally, adjacent campaigns and/or campaigns on the same or closely located devices may also be displayed for the user during creation and management of campaigns.

The user interface may also allow for content creation and management. The user may create new content or modify existing content (including the layout of existing content). In addition, the user may preview the content to determine appropriateness and effectiveness of the content and its layout on the sign.

The user interface may also allow the user to select those signs on which the campaign will be run. This may be done, for example, on a drag and drop user interface, wherein all of the available signs may be identified to the user who may then select the signs for the campaign by dragging the sign identifier to the assigned sign category.

General Functionality

The system, in either an enterprise configuration or for a single or small number of signs, may permit communication with the data storage device via a handheld device utilizing wireless communication. In an embodiment, a handheld scanner may be used to change the sign display on the sales floor. The scanner permits a sales floor associate to update the display of a particular sign instantaneously. The handheld device may scan a unique identifier associated with the sign, such as a bar code, and a unique identifier code associated with a particular product, such as a UPC. This information may be communicated from the handheld device by known wireless communications methods to the interface with the general data storage device. The data storage device may then access an appropriate message presently associated with the scanned product code and may communicate the message via a proxy to the sign identified by the handheld scanner. In this way, signs may be added to a retail environment quickly and sign layouts among an entire store floor or retail environment may be quickly changed to meet the needs of a particular retailer, event or product cycle. In addition, the system may be configured to allow the handheld device to scan the unique identifying code associated with the sign and enter a code for a location within the store. In this embodiment, the information is communicated to the server of the on-site processor, which preferably identifies an appropriate message to be displayed at that location and communicates such message, via the proxy described above, to the identified sign.

In an embodiment, the Shopper's Answer Machine™ (“SAM”) 108 is an interactive kiosk which is capable of being combined with the present system, or standing alone, in any on-site network and utilizing an on-site or remotely located corporate database. With a SAM 108, retail customers may access information about a particular product, such as the price of the item, in the store. In addition to providing product information to a customer, the SAM 108 may simultaneously deliver customized upsell/cross-sell messages. The SAM 108 may utilize an LCD and touch screen for providing interactive display functionality to the user. In addition, the SAM 108 may utilize a display engine which scans the UPC of any item. The UPC may be used to access corporate databases to obtain pricing and detailed product information. The pricing and product information may be displayed on the screen of the SAM 108. Additional images and/or advertisements regarding the product, such as full motion video images of the product in action, may also be displayed on the SAM's screen. In addition, cross-sell messages regarding the compatibility of the product may be displayed, encouraging additional sales. When not being utilized by a specific customer to display product information, the device 108 may function as a dynamic display sign showing promotions or other messages, such as a map.

Although the present systems and methods have been described herein with respect to their use and implementation in a retail environment, it will be apparent to one of ordinary skill in the art that the present systems and methods will be effective in any setting in which a plurality of changeable signs are desired. Accordingly, as used herein, “store” shall mean any environment in which a network of signs is utilized, including by way of example only, airports, train or subway stations, schools, convenience stores, gas stations, office buildings, hotels/motels, arenas, stadiums, and other networks of indoor or outdoor advertising.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-readable medium comprising program instructions thereon that instruct a computer to:
receive data corresponding to a campaign;
retrieve, from a content database, sign data corresponding to the campaign;
select one or more signs within a sign network to which the sign data applies; and
selectively transmit, via a communications network, at least a portion of the sign data to the selected one or more signs.

2. The medium of claim 1, wherein the sign data comprises an identification of one or more signs within the sign network.

3. The medium of claim 1, wherein the sign data comprises one or more of the following:
at least one store;
at least one department with a store;
a display field;
a stock keeping unit number;
a start time;
an end time;
a serial number; and
a sign type.

4. The medium of claim 1, wherein the program instructions also instruct the computer to transmit at one or more predetermined times, updated sign data corresponding to the campaign to the selected one or more signs.

5. The medium of claim 1, wherein the program instructions also instruct the computer to transmit a wake-up signal to the selected one or more signs.

6. A system for managing content displayed on a distributed network of signs, comprising:
a central processor;
a computer-readable storage medium operably connected to the central processor;
a communications network operably connected to the central processor;
one or more on-site processors operably connected to the communications network; and
one or more first signs, wherein each first sign is operably connected to at least one on-site processor;
wherein the computer-readable storage medium comprises program instructions for performing a method of managing content displayed on a distributed network of signs, the method comprising:
creating sign data pertaining to a campaign and at least one first sign within the network of signs;
storing the sign data in the computer-readable storage medium,
transmitting at least a portion of the sign data to an on-site processor operably connected to a first sign to which the portion of the sign data pertains;
transmitting the portion of the sign data to the first sign to which the portion of the sign data pertains; and
updating the first sign based on the transmitted portion of the sign data.

7. The system of claim 6, wherein the sign data comprises, for each sign to which the sign data pertains, one or more of the following:
a store where the sign is located;
a department where the sign is located;
a location;
one or more display fields;
a size for each display field;
information to display on the sign;
a stock keeping unit number;
a start time for displaying the information;
an end time for displaying the information;
a wake-up schedule;
a campaign;
a serial number;
a rack number;
an aisle number;
a power source type;
a sign type; and
a firmware version number.

8. The system of claim 6, wherein the communications network comprises a wireless network.

9. The system of claim 6, wherein the communications network comprises a wire-based network.

10. The system of claim 6, wherein the at least one first sign is wirelessly connected to at least one on-site processor.

11. The system of claim 6, wherein the at least one first sign is connected by wire to at least one on-site processor.

12. The system of claim 6, further comprising an interactive kiosk operably connected to the communications system.

13. The system of claim 12, wherein the interactive kiosk comprises:
a kiosk processor;
a kiosk display; and
a kiosk computer-readable storage medium,
wherein the kiosk computer-readable storage medium comprises program instructions for performing a method for providing interactive display functionality to a user, the method comprising:
receiving a user selection for an item,
retrieving information pertaining to the item from a database, and
displaying the information.

14. The system of claim 13, wherein the method for providing interactive display functionality further comprises displaying one or more of an upsell message and a cross-sell message.

15. The system of claim 13, wherein the database is remote from the kiosk.

16. The system of claim 13, wherein the kiosk computer-readable storage medium contains the database.

17. The system of claim 13, further comprising a kiosk scanner, wherein receiving a user selection comprises scanning an identification code from an item using the kiosk scanner.

18. The system of claim 17, wherein the identification code comprises a universal product code or a stock keeping unit code.

19. The system of claim 6, further comprising:
one or more gateways, wherein each gateway is operably connected to at least one on-site processor; and
one or more second signs, wherein each second sign is operably connected to at least one gateway,
wherein the computer-readable storage medium contains program instructions for performing a method for managing content displayed on a distributed network of signs, the method comprising:
creating second sign data pertaining to at least one second sign,
storing the second sign data in the computer-readable storage medium,
transmitting at least a portion of the second sign data to an on-site processor operably connected to a gateway to which the portion of the second sign data pertains,
transmitting at least a portion of the second sign data to the gateway operably connected to a second sign to which the portion of the second sign data pertains,
transmitting the portion of the sign data to the second sign to which the portion of the second sign data pertains, and
updating the second sign based on the transmitted portion of the second sign data.

20. A method for managing content displayed on a distributed network of signs, the method comprising:
creating sign data pertaining to a campaign;
transmitting at least a portion of the sign data to an on-site processor operably connected to a gateway;
transmitting the portion of the sign data to the gateway;
transmitting the portion of the sign data to a sign to which the portion of the sign data pertains; and
updating the sign based on the transmitted portion of the sign data.
